(19) United States
(12) Patent Application Publication
(10) Pub. No.: US 2021/0221085 A1
(43) Pub. Date: Jul. 22, 2021

(54) DISCHARGE CHUTE FOR A TABLET MACHINE AND A METHOD FOR SORTING PELLETS AFTER THEY HAVE BEEN PRODUCED IN A TABLET MACHINE

(71) Applicant: KORSCH AG, Berlin (DE)

(72) Inventors: Ingo KLAER, Berlin (DE); Pierre BRAUN, Berlin (DE); Stephan MIES, Berlin (DE)

(73) Assignee: KORSCH AG, Berlin (DE)

(21) Appl. No.: 15/734,716

(22) PCT Filed: Jun. 3, 2019
(86) PCT No.: PCT/EP2019/064316

§ 371 Date: Dec. 3, 2020

(30) Foreign Application Priority Data
Jun. 4, 2018 (EP) 18175666.9

(51) Int. Cl. B30B 15/32

(52) U.S. Cl. CPC B30B 15/32

(57) ABSTRACT

The invention relates to a discharge chute (1) for a tablet-making machine, and to a method for sorting tablets after they have been produced in a tablet-making machine. The discharge chute (1) is characterised in that the channels (4, 5, 6, 13), into which the tablets are guided and/or sorted after they have been produced, are arranged on two planes (2, 3), the sorting of the tablets taking place with tandem sorting devices (7, 14). A sorting device preferably comprises two bars (8, 9, 10, 11), which are preferably designated as sorting bars (8, 10) and as separating bars (9, 11). The sorting bar (8, 10) preferably comprises a linear drive (17), which is preferably connected by means of a rocking lever (22) to the separating bar (9, 11). If the sorting bar (8, 10) moves upwards out of the rest position into the sorting position, the separating bar (9, 11) falls downwards automatically and frees the opening of the sorting channel.

The invention relates to a discharge chute for a tablet machine and a method for sorting pellets after they have been produced in a tablet machine. The discharge chute is characterized in that the channels into which the pellets are sorted after they are produced are arranged on two levels, wherein the pellets are sorted using sorting devices that can alternately release or block the entrances to the channels.

### GENERAL BACKGROUND AND PRIOR ART

Tablet machines are used in many branches of industry to compress powdered or granulated materials into solid pellets. In the pharmaceuticals industry, this may involve numerous forms of tablets, in the chemicals industry this may involve dishwashing detergent tablets, toilet cleaner tablets, fertilizer sticks, or catalysts, and in the foods industry it may involve peppermint tablets or glucose tablets, for example. Above all the sub-class of rotary presses was developed primarily for producing solid and stable pellets in large quantities from powdery or granulated compression materials that are dry, pourable, and free-flowing, within extremely narrow weight tolerances. For the purposes of the invention, this compression material is preferably also referred to as tablet material. In the case of a rotary tablet press, the tablets are produced in the openings or bores of a die plate by compressing the tablet material, which the tablet will later consist of, between an upper punch and a lower punch to form a pellet. The tablet material is compressed into pellets in openings and/or bores on the die plate, wherein the die plate can be part of a rotating rotor. For the purposes of the invention, it is preferred that the rotor rotates about a rotor axis, wherein the rotor axis is preferably formed perpendicularly to a preferably flat rotor surface and/or rotor lower side. After the pressing process, the tablets and/or pellets are ejected from the openings of the die plate by lifting the lower punch so that they come to rest on the surface of the die plate. Of the tablets and/or pellets that are on the upper side of the die plate, the “good” tablets are guided outwards by an inclined tablet scraper on the upper side of the die plate into an inlet of a tablet discharge chute.

The discharge chute is a central component of a tablet machine, in particular a rotary press, because it is used to guide the tablets and/or pellets produced using the machine out of the pressing chamber of the rotary press from the surface of the die plate via the tablet scraper. In its simplest form, the chute consists of a simple U-shaped channel which is installed in a stationary manner using a holding device on a machine base, on a corner bar, or on a carrier plate of the tablet machine and protrudes at an angle from the upper side of the die plate diagonally downward out of the tablet machine. The discharge chutes known from the prior art usually extend through a machine cladding or a window in the housing of the tablet machine, so that the tablets and/or pellets can leave the pressing chamber of the tablet machine to be processed further.

The running surfaces of the discharge chute on which the tablets leave the tablet machine should be flat and very smooth so that the tablets can leave the discharge chute as smoothly and unbraked as possible. In the past, the chutes were made of chromed sheet steel. Sheet metal chutes are usually made of thin material having a wall thickness of 1-2 mm. The sheet metal blanks are usually folded, perforated, and welded. Since the material warps as a result of the heat treatment, the finished welded discharge chutes are straightened and then ground or polished. If handled carefully, the stainless steel chutes have a long service life and a lasting surface quality, even if they are used 3 shifts a day. Most of the time, however, the chutes are damaged, deformed, and bent by rough handling, so that they cause problems in use in the tablet machine. This is due to the fact that this type of discharge chute is not stable enough for continuous daily use.

For this reason, whole-part discharge chutes that are milled from a block of plastic or aluminum have become popular in recent years. These chutes, which are made from a solid material, are more complex and expensive to manufacture than sheet metal chutes, but are much more stable and they do not cause any problems in production.

A large number of tablet and pellet formats are produced in large numbers using tablet machines. There are small and large, as well as light and heavy tablets, wherein all of these tablets leave the tablet machine via the tablet discharge chute. It is therefore a concern of the present invention to provide a tablet discharge chute using which tablets having different geometries, sizes, and weights can be removed from the pressing chamber of the tablet machine without interference and without undesired jamming or tilting.

So that the tablets can leave the chute as smoothly as possible and due to gravity, the discharge chute has to have a steep incline outward from the die plate. However, the steepness of the discharge chute makes it difficult to connect the discharge chute to the die plate of the tablet press without any obstacles, since the surface of the die plate is horizontal and flat. Another concern of the present invention is accordingly to design the transition region between the die plate and the discharge chute with as few obstacles as possible and so it is less susceptible to malfunction.

Conventional discharge chutes can comprise up to four channels for receiving different tablets. A conventional chute can for example comprise a good channel into which the tablets found to be “good” are guided. Another channel can be referred to as a “sample channel”. It can be used for random samples that are taken from the tablet flow in the good channel or for sample tablets that are produced at the beginning of a production cycle or when the tablet machine is started up. A third channel can be used, for example, for reject tablets from the good channel. Another channel can be designed to accommodate tablets that have been found to be “bad”. This channel is preferably also referred to as a “bad channel”, wherein it is possible for the bad tablets to be rejected, for example, using an individual sorting device. The rejection includes in particular a separation of the “good” from the “bad” tablets.

The individual channels are usually in one level next to each other in the discharge chute, so that the conventional chutes can thus become very wide and heavy. The dimensions of the chute and also the weight of the parts also increase if the tablet machine is also to be used to produce large tablets having a diameter of, for example, 25 mm and a thickness of 5 mm. For these large tablets, the channel width has to be designed so that two tablets next to each other together with a vertical tablet between the two flat tablets have enough space and do not get stuck between the usually vertical channel walls. A tablet jam with these large tablets is particularly critical because the high tablet weight of multiple grams per tablet and the large volume of the tablets clog the channel particularly quickly and the tablets, the broken tablets, and the dust can be undesirably distributed throughout the pressing chamber. This can lead to a machine shutdown and a necessary general cleaning. If two tablets are next to each other and there is a vertical tablet between them, the above exemplary dimensions result in a required width of 55 mm for a channel of the discharge chute. Since some play and free space is usually planned in addition in relation to the side walls of the channel, conventional chute channels can have a clear inner width of, for example, 60 mm. A four-channel chute for large effervescent tablets would result in a total clear width of 240 mm, so that the chute plus the separating webs between the channels has a total width of 255 mm. However, such chutes are very unwieldy and very heavy due to their production from a solid material. In addition, it is a major technical challenge to connect such a wide discharge chute to the die plate without any obstacles or disruption in order to guide the tablets out of the pressing chamber of the tablet machine without the formation of backlogs.

From a technical point of view, a particular challenge is that the die plate is in a horizontal plane and the tablet discharge chute meets the outer side of the die plate at a relatively steep angle. If the chute is placed in the middle of the die plate, the central channels can still be adapted well to the horizontal level of the die plate. However, adapting the outer channels poses a challenge, because they are far from a virtual centerline or central axis of the chute and the die plate. With conventional discharge chutes, this challenge is solved by using horizontal fitting plates in the region of the outer chute channels, which should enable the transition from the chute to the die plate. The disadvantage of this makeshift solution, however, is that horizontal surfaces result with respect to the chute inclination, on which the tablets often remain because the fitting plates are in the same plane as the die plate.

A capsule filling machine is known from U.S. Pat. No. 3,097,161 A, in which a discharge chute for the filled capsules comprises a compressed air device which, due to their lower weight, blows incompletely filled capsules onto a plane arranged above the discharge chute. The sorting mechanism shown there, however, does not allow capsules to be sorted into different subsets due to properties other than their weight. However, this mechanism is also unsuitable for differentiating between capsules with small differences in weight, since only objects having a sufficiently large surface and at the same time large differences in weight can be sorted by such a compressed air mechanism. In addition, the described mechanism for sorting has to work against gravity and always requires sufficient energy to be made available to raise a capsule to a higher level against gravity.

Another disadvantage of known tablet discharge chutes are the sorting gates used, using which tablets can be channeled from one channel into another. In some devices from the prior art, the sorting gates are located as flaps in the running surface of the channels, wherein these flaps can open either upwards or downwards, whereby, for example, flawed tablets are rejected. The disadvantage here is that when the flap is closed after the sorting process, “good” tablets can get jammed between the flap and the channel bottom, which often leads to an undesirable backlog.

In the prior art, rotatable metal tabs are also known as sorting gates, which are arranged perpendicular to the running surface of the chutes. For example, U.S. Pat. No. 8,078,329 B2 describes a tablet machine having such metal tabs. These simple tabs or also U-profiles are provided in the idle state in a bulge on a flank or side in the good channel. The construction of the gates and the embodiment of the switching tabs or U-profiles has to be light enough for the required high rotational speed, but on the other hand also stable enough so that the switching tabs do not have to be straightened and bent into shape after each washing process of the chutes. If the switching tabs or the axis of rotation are bent, the underside of the switching tab rubs against the running surface of the channel and the switching tab blocks before reaching the end position. If the deformation of the switching tab results in too great a distance between the lower edge of the switching tab and the running surface of the channel, tablets can get jammed in the gap, which can adversely affect the function of the gate. In this case, too, there is often a backlog of the tablets which can extend back to the rotor and thus make the tablet machine impossible to operate. Often these switching tabs are operated using rotary magnets. These have the disadvantage that they are only operated actively using current in one direction and they are reset by spring force. In particular with the rotatable switching tabs having these less than optimal rotary drives, tablets often got jammed between the lower edge of the switching tab and the bottom plate of the chute. Then the switching tab jammed and blocked in any position and the tablets could get uncontrollably into one or the other—wrong—channel.

It is therefore the object of the present invention to provide a discharge chute for a tablet machine and a method for sorting pellets after they are produced in a tablet machine which do not have the deficiencies and disadvantages of the devices known from the prior art. In particular, the discharge chute to be provided is to be able to be connected to the die plate of the tablet machine in such a way that the transition from the die plate to the discharge chute can take place as smoothly as possible and without causing a backlog of tablets. This is to be enabled in particular for tablets having different geometries, sizes, and weights. In addition, sorting devices are to be arranged in the discharge chute, which enable an uncomplicated transfer of the tablets from one channel to another within the discharge chute. In addition, the discharge chute to be provided is to be easy to handle and have the lowest possible weight. The method to be provided is intended to ensure efficient and backlog-free sorting of pellets and their distribution to different channels of the discharge chute.

### DESCRIPTION OF THE INVENTION

The object is achieved by the features of the independent claims. Advantageous designs of the invention are described in the dependent claims. According to the invention, a discharge chute for a tablet machine is provided which comprises a first channel and one or more further channels for receiving pellets. The discharge chute is characterized in that the discharge chute comprises a first and a second level, wherein the two levels are arranged one above the other and the first, upper level comprises the first channel, as well as entrances for the further channels, wherein the discharge chute comprises one or more sorting devices which are designed to release or block at least some of these entrances, whereby the pellets are divided into subsets of pellets. It is particularly preferred that at least one of the subsets of pellets reaches the second, lower level via at least one of the further channels.

The proposed discharge chute can be made particularly narrow due to its design in two levels, and can be fastened to a tablet machine in an uncomplicated and simple manner in order to guide the pellets out of the pressing chamber of the tablet machine and feed them to the corresponding outlets. It has been shown that the transition between the die plate of the tablet machine and the proposed discharge chute can be made particularly “smooth” and without obstacles for the pellets due to the narrow embodiment of the discharge chute, which efficiently prevents the formation of misrouting and backlogs into the pressing chamber. In the event of a misrouting, a flawed tablet remains on the preferably horizontal fitting plates for the purposes of the invention. After some time, the vibrations can cause it to slip off the sheet metal and thus pass into the good channel in an uncontrolled manner, so that it undesirably leaves the rotary press with the tablets found to be “good”.

Because the sorting channels of the proposed discharge chute are arranged in two levels, the individual channels can be made wider than in conventional discharge chutes, in which the channels are arranged in one level. This ensures that, using the proposed discharge chute, pellets having different geometries, sizes, and weights can flow particularly smoothly and safely through the channels of the discharge chute, in particular without tilting or jamming. This avoids unwanted backlogs and prevents the pellets from breaking if large forces act on the pellet in the event of a tilt. For the purposes of the invention, it is preferred that the terms “tablets” and “pellets” are used synonymously.

Advantageously, channels arranged adjacent to one another in the upper level can be very wide, since further channels can be arranged in the second, lower level. Thus, for example two upper channels each have a clear width of 60 mm, so that advantageously two larger tablets, such as effervescent tablets, having a diameter of 25 mm can pass the chute next to one another and with a tablet vertically between them, without jamming. A chute shaft in the lower level, for example under the second chute channel, is then preferably intended for the removal of the rejected single tablets and the rejected mean value tablets.

The two-story tablet discharge chute enables, on a width of, for example, ONLY at most 120 mm in total, for example 4 different channels, all of which are suitable for handling different tablets, in particular especially large effervescent tablets. Furthermore, the necessary gate switchover for guiding the tablet streams is preferably carried out by means of vertically movable tandem blades (webs), between which tablets or broken tablets can no longer jam.

A maximum shaft width for tablet chutes has become necessary in particular due to the usual use of interchangeable rotors. Since the rotor—and thus also the tool format—can preferably be changed in all modern rotary presses, one machine can advantageously manufacture very small tablets but also very large tablets, such as effervescent tablets. Since one does not wish to use a separate tablet discharge chute for every tablet format, every tablet format is supposed to be able to be transported without problems using the chute. A “standard chute” can be used to compress tablets having a diameter of up to 25 mm. For reasons of stability alone, the chutes should preferably not be wider than 120 mm. Thus, the available space for the chute is limited in width. Advantageously, the device enables a 4-way tablet discharge chute having a width of in particular 120 mm and a shaft width of 60 mm each, wherein the 4 shafts are preferably distributed over two levels and the tablet streams are preferably guided by means of two vertically working tandem blades (webs) that can no longer jam.

Advantageously, the webs can be used for rejecting flawed mean value tablets in channels numbers 3+4, preferably in a lower level, and for rejecting sample tablets in a channel number 2. Bad single value tablets are preferably fed into channel number 4 via the individual sorting by means of compressed air. For the linear drives of the tandem blades, a corresponding space is preferably required below channel number 1. At the outer end of this lower channel there is advantageously a connection for a dust extraction system for the two upper channels numbers 1+2.

Application tests have shown that the proposed discharge chutes are lighter in weight than conventional discharge chutes, having the widths and sheet metal or material thicknesses described in the prior art. Due to the compact, narrow embodiment, which is ensured by the proposed discharge chute, the discharge chute is easy to handle and particularly user-friendly for an operator or controller of the tablet machine. It is a particular merit of the invention that the proposed arrangement of the elements of the discharge chute means that the first, upper level of the discharge chute can be provided without electrical components, so that this upper level of the discharge chute can, surprisingly, be washed and a washable embodiment can be made available to the customer, which can result in savings in terms of personnel and costs in the daily operation of the discharge chute. Surprisingly, the second, lower level of the discharge chute can also be washed if electrical components associated with the second, lower level of the discharge chute have been removed beforehand, such as jam sensors or the two linear drives that drive the sorting devices or their elements. In the context of the invention, it is particularly preferred that wet cleaning is possible in a washing machine for components of a tablet machine.

Further advantages of the invention are that the proposed discharge chute has a particularly stable and torsion-resistant shape, so that the discharge chute withstands the high mechanical loads in long-term use. Because the discharge chute can be manufactured from stainless steel, plastic, and/or aluminum, the proposed discharge chute can be approved by the FDA USA. In the context of the invention, it is particularly preferred that aluminum is finished using a nickel coating and/or that iron or steel materials are protected against corrosion by nickel plating and/or chrome plating. In the context of the invention, it is particularly preferred that the discharge chute comprises stainless steel 316L, since the use of this stainless steel ensures that the protective layers made of nickel and/or chromium do not wear out or detach even under very high or long loads. Due to the materials used and the design of the discharge chute, particularly smooth running surfaces can be permanently provided for the tablets, whereby jamming, tilting, or the formation of backlogs can be effectively avoided. It was completely surprising that a discharge chute can be provided which can be installed and removed without tools. This can be achieved, for example, in that the proposed discharge chute is attached to a chute support using quick-release fasteners. Furthermore, in conjunction with the use of the proposed discharge chute, backlog monitoring in the good channel can take place, whereby a backlog in the pressing chamber of the tablet machine can be avoided particularly effectively.

It is within the meaning of the invention that the proposed discharge chute comprises multiple sorting channels into which the pellets can be sorted after they are produced in the pressing chamber of the tablet machine depending on their properties. In particular, the discharge chute comprises a first channel and one or more further channels. The pellets or tablets, which are ejected from openings in the die plate by lifting the lower punches and come to rest on the die plate, are preferably conveyed into the transition region of tablet machine and discharge chute, in particular die plate and discharge chute, by a tablet scraper which is preferably located at a slight distance above the die plate. A first sorting process takes place in this transition region, in which the flow of pellets or all of the pellets produced is divided into two subsets of pellets. For the purposes of the invention, the term “subset of the pellets” subsumes those pellets that are located in the same sorting channel of the discharge chute after a sorting process has been completed. The proposed discharge chute has two entrances for the pellets in the transition region, wherein a first entrance opens into a first channel of the discharge chute and this first channel preferably receives a first subset of pellets.

The first channel of the discharge chute is preferably designed as a continuous channel, at the end of which there is an outlet for a first subset of pellets. The first channel is part of the first upper level of the discharge chute, which in the context of the invention is preferably also referred to as the upper level of the discharge chute. For the purposes of the invention, it is preferred that in particular the first, upper level of the discharge chute is arranged at essentially the same height as the substantially horizontal plane of the die plate of the tablet machine, whereby the tablets can advantageously pass unhindered from the pressing chamber to the discharge chute. For the purposes of the invention, it is preferred to designate the first channel as a good channel. The pellets that have been found to be “good” and thus correct by the various test devices and monitoring mechanisms are preferably sorted into the good channel, so that they can be sold to retailers and consumers. These pellets found to be “good” preferably form the first subset of pellets and are preferably referred to as “good tablets” for the purposes of the invention. The good channel is designed as a continuous channel so that the tablets found to be “good” can pass from the transition region between the tablet machine and the discharge chute directly into the region of an outlet of the good channel, which is preferably located at the end of the good channel on the side of the discharge chute opposite to the tablet machine. This side of the discharge chute, at which the outlets of the sorting channels are preferably located, is preferably referred to in the context of the invention as the outlet of the discharge chute, while the side of the discharge chute that forms the transition region to the tablet machine is preferably referred to as the upper inlet of the discharge chute. According to the invention, it is preferred that the good channel is delimited by side walls, wherein the good channel is preferably delimited on one side by an outer wall of the discharge chute and on its other side by a center wall of the discharge chute arranged essentially in the center of the discharge chute. This center wall preferably has two openings which are preferably used as entrances to the third and fourth channels of the discharge chute and which can be released or blocked using the webs of the first and second sorting device.

The proposed discharge chute has a second entrance in the transition region, which preferably opens into a second channel of the discharge chute. This second channel is preferably designed to receive a second subset of pellets. These tablets of the second subset are preferably those tablets that were rejected at the tablet scraper using compressed air and found to be flawed. These tablets, which preferably form the second subset of pellets, are preferably also referred to as “bad tablets”. The bad channel comprises a short channel section which is preferably surrounded on three sides by a fixed side wall. A side wall is preferably formed by the center wall of the discharge chute and the opposite side is formed by an outer wall of the discharge chute. The center wall and the outer wall are preferably connected to a connecting wall, wherein this connecting wall forms the rear end of the bad channel and delimits the bad channel to the rear, so that no pellets of the second subset can pass into another channel of the upper level of the discharge chute. In the bottom of the bad channel, an opening is preferably arranged through which the pellets of the second subset can fall into the second level of the discharge chute, which is also referred to as the lower level. According to the invention, it is preferred that the second level comprises a fifth channel, which is preferably also referred to as a collecting channel. In the collecting channel, those pellets are preferably collected that were guided into the second or third channel of the discharge chute, i.e. preferably form the second and third subset of the pellets. These tablets are preferably the bad tablets that have been rejected using compressed air in the area of the tablet scraper because they are flawed, or the reject tablets from the good channel, which were guided using the first sorting device into the reject channel, i.e. the third channel of the discharge chute. For the purposes of the invention, it is preferred that the fifth channel is designed to feed the bad tablets and reject tablets to an outlet, which is preferably part of the second, lower level of the discharge chute. In the context of the invention, it is preferred that the collecting channel is arranged in the second level, in particular below the second, third and fourth channel and thus preferably essentially fills one half of the lower level, while the other side half of the lower level preferably comprises the linear drives of the sorting devices, which are preferably provided fastened to a bottom of the second level of the discharge chute. For the purposes of the invention, it is preferred that the bad channel has an opening in its bottom so that the pellets that pass into the second channel fall through this opening into the collecting channel of the second level of the discharge chute.

In the context of the invention, it is preferred that the upper level of the discharge chute is divided by a center wall into two essentially similarly wide side halves. While one side, for example the left side in plan view from the direction of the tablet machine, of the preferably continuous first channel, which preferably forms the good channel for the tablets found to be “good”, the other side half, in plan view from the direction of the tablet machine, for example the right side, is preferably formed by the second, third, and fourth channel, in other words by the bad channel, the reject channel, and the sample channel of the discharge chute. The center wall, which preferably marks this separation, preferably has two openings through which the pellets can pass from the good channel, i.e., from the first subset of pellets, into the third or fourth channel of the discharge chute.

The third channel is preferably also referred to as a reject channel. It preferably receives the tablets from the good channel that are outside a previously defined weight tolerance. Such tablets can be produced, for example, at the beginning and as the tablet machine is being started up or when a production process is ended or interrupted. But also during production, if, for example, there is a malfunction in the pressing material supply or there is a bridging in the material supply and thus a reduction in the flow of material into the filling device or the pressing material is coming to an end, the pressing force mean value can deviate considerably from the target value, whereby it is necessary to reject these tablets into the reject channel. For the purposes of the invention, it is preferred that the reject channel has an opening in its bottom, so that the pellets that get into this third channel fall through this opening into the collecting channel of the second level of the discharge chute and are fed to the outlet in the second level for rejected tablets. For the purposes of the invention, it is preferred to designate the entrance of the third channel as the first opening in the center wall of the discharge chute.

The fourth channel of the discharge chute is preferably also referred to as the sample channel. It can preferably be used for random samples that are taken from the tablet flow in the good channel or for sample tablets that are produced at the beginning of a production cycle or when the tablet machine is started up. The tablets that pass into the fourth channel of the discharge chute are preferably also referred to as sample tablets; they preferably form the fourth subset of pellets. For the purposes of the invention, it is preferred that the sample channel has no opening in its bottom, wherein the fourth subset of pellets enters an outlet for the fourth subset of pellets, wherein this outlet is part of the first, upper level. Preferably, tablets of the fourth subset of pellets are also referred to as sample tablets. For the purposes of the invention, it is preferred that the second sorting device can be used to remove tablet samples from the good channel. The sample tablets preferably leave the good channel through the opening in the center wall of the discharge chute and thereby pass into the sample channel, at the end of which an outlet for sample tablets is arranged. This outlet for sample tablets is preferably arranged at the rear, preferably left end of the first, upper level of the discharge chute. The sample tablets can be collected there in bags or small containers. For the purposes of the invention, it is preferred to designate the entrance of the fourth channel as the second opening in the center wall of the discharge chute.

For the purposes of the invention, it is preferred that the two openings in the center wall of the discharge chute, which preferably form the entrances for the third and fourth sorting channels, can be opened and closed using sorting devices. For the purposes of the invention, it is particularly preferred that the pellets are guided from the first channel into a third channel using the first sorting device and that the pellets are guided from the first channel into a fourth channel using the second sorting device. In other words, the first sorting device is designed to guide pellets from the good channel into the reject channel, while the second sorting device is designed to guide pellets from the good channel into the sample channel. In this respect, the sorting devices preferably function as gates which are designed to channel a flow of pellets in the sense that, for example, either a passage through the continuous good channel in the first, upper level of the discharge chute is permitted or that a pellet or a group of pellets is guided into an opening in the center wall of the discharge chute, whereby the pellet or the group of pellets is rejected from the one continuous good channel.

Preferably, the invention provides a compact, narrow two-lane tablet discharge chute which fulfills the function of a wide four-lane tablet discharge chute in that the discharge chute has an upper and a lower level, wherein with the channels for good, sample, reject, and bad tablets are located in the upper level, and wherein the collecting channel for the tablets from the reject channel and the bad channel is located in the lower level, as well as the mechanical drive for linearly movable sorting and separating webs, which in turn are connected to one linear drive per web pair and sorting device. The particularly compact, narrow design of the tablet chute in particular enables different tablet formats, geometries, sizes, and weights, to leave the chute smoothly, in particular due to gravity.

For the purposes of the invention, it is preferred that the first sorting device guides the reject tablets into the reject channel, in particular due to the inclined positioning in the good channel, and that the second sorting device guides the sample tablets from the good channel into the sample channel, in particular due to the inclined positioning in the good channel. For the purposes of the invention, it is preferred that the first, upper level comprises entrances for a second channel, third channel, and fourth channel, which are designed to receive a second, third, and fourth subset of pellets, wherein sections of the second and third channel comprise openings in a bottom of the first, upper level, through which the second and third subset of pellets can pass into the second, lower level. For the purposes of the invention, it is preferred, for example, that the reject channel in the upper level has no bottom, so that the tablets that are guided into this third channel fall down into the lower level in the collecting channel, which preferably represents a fifth channel for the purposes of the invention. For the purposes of the invention, it is particularly preferred that the bad tablets rejected individually by compressed air in the area of the tablet scraper are guided into the bad channel in the upper level and that these bad tablets fall through an opening in the channel floor into the collecting or waste channel located below, wherein the bad channel represents the second channel within the meaning of the invention and the collecting channel represents the fifth channel within the meaning of the invention. For the purposes of the invention, it is preferred that the second, lower level has an outlet for the second and third subset of pellets, wherein this outlet is part of the second level and represents the rear end and the outlet of the collecting channel.

It is further preferred that the second and third subset of pellets pass into the second, lower level through the openings in the bottom of the first, top level. In other words, it is preferred that the pellets and tablets rejected directly by the scraper using compressed air, which represent rejects from the good channel, pass through the openings in the bottom of the first, upper level into the second, lower level. The fourth subset of pellets preferably passes into an outlet for the fourth subset of pellets, wherein this outlet is part of the first level. These are preferably sample tablets that can be taken out of the discharge chute via a separate outlet.

For the purposes of the invention, it is preferred that the sorting devices comprise a first web and a second web, wherein the webs are connected to one another via a linear drive in such a way that an upward movement of the first web causes a downward movement of the second web and vice versa. The use of stable webs is particularly advantageous compared to the thin metal sheets known from the prior art, because the stable webs cannot bend. A sorting device preferably comprises in each case a sorting web, which is preferably placed at an incline and which can be raised substantially vertically from a bottom position in the good channel to an upper sorting position via a linear drive. The first web and the second web of a sorting device are preferably referred to as a “web pair”. The first web can preferably be referred to as a sorting web, which is preferably provided extending inclined in the good channel. The second web can preferably be referred to as a separating web. The two separating webs of the sorting devices are preferably arranged in the entrances of the third channel and the fourth channel of the discharge chute, wherein the separating web of the first sorting device is arranged in the entrance of the reject channel and the separating web of the second sorting device is arranged in the entrance of the sample channel. The separating webs of the two sorting devices preferably extend essentially in parallel to a movement of the pellet flow in the first channel in the first, upper level of the discharge chute. The two sorting webs of the two sorting devices extend, for example, inclined within the good channel.

Each web can be in a bottom position or idle position in the bottom of the first, upper level of the discharge chute or in a sorting position. When a web is in a sorting position, it is preferably designed to block the entrance or the channel in which it is present, while it releases the entrance or the channel in which it is present in the bottom position. This movement of the two interconnected webs of a sorting device is preferably referred to in the context of the invention as “alternating blocking and releasing” of the channel entrances. In other words, a web that is in a sorting position prevents the pellets from passing through the entrance or channel in which the corresponding web is present, while the web releases the passage of the pellets through the entrance or channel in which it is present when the corresponding web is in the bottom position. The bottom position is preferably characterized in that the web is sunk in a base plate of the upper level of the discharge chute and is preferably flush with it, so that the pellets produced can flow over the web sunk in the base plate. The sorting position or working position of a web can preferably also be referred to as the extended position of the web.

In other words, for the purposes of the invention, it is preferred that the channels of the discharge chute into which the pellets are sorted after they are produced are arranged on two levels, wherein the pellets are sorted using tandem sorting devices. A sorting device preferably comprises two webs, which are referred to as sorting web and separating web. The sorting web preferably comprises a linear drive, which is preferably connected to the separating web via a rocker. If the sorting web moves upwards from the idle position into the sorting position, the separating web is automatically lowered downwards by spring action and releases the opening of the sorting channel.

A particular merit of the proposed discharge chute is that the essentially vertical up and down movement of the webs prevents tablets or fragments of tablets from being able to jam between the webs and the bottom of the chute, which could undesirably disable the sorting devices. In the idle position, the sorting webs are located flush in the bottom of the chute, with which the webs are advantageously flush so that the flow of tablets is not impeded. In the working position, the separating webs are in the extended position and reliably prevent “good” tablets from passing into the wrong channels.

For the purposes of the invention, it is preferred that parallel to an upward movement of a sorting web, the separating web of the corresponding sorting device, which preferably closes the entrance to the channel located behind it, is moved downwards synchronously, thus releasing the corresponding channel for the tablets to be rejected. The sorting devices of the proposed discharge chute are preferably designed to be essentially identical. It is preferred that the sorting web of a sorting device is raised and lowered via a linear drive and that the separating web of the sorting device is mechanically coupled to the stroke of the sorting web, for example by means of a rocker, wherein the two webs of the sorting device thus advantageously exert a movement in opposite directions. In the context of the invention, it is preferred that the linear drives of the sorting devices are fastened to a bottom or a bottom plate of the second, lower level of the discharge chute. The linear drives can preferably be operated electrically, pneumatically, by motor, and/or hydraulically.

In a preferred embodiment of the invention, the sorting devices each comprise a first web and a second web, wherein the webs are connected to one another via a linear drive in such a way that an upward movement of the first web causes a downward movement of the second web and vice versa. The connection between the two webs includes, in particular, a rocker or a type of rocker, which is preferably rotatably mounted and comprises rocker arms on both sides of the bearing, wherein a first arm preferably cooperates with the first web and the second arm with the second web. This can be implemented, for example, in that the arms and webs are arranged corresponding to one another and/or the webs are shaped accordingly so that they only interact with one of the two arms in each case, for example by way of matched recesses. The drive comprising the lever is arranged in particular below the webs and interacts with their lower sides. The arms can preferably be arranged along a line with respect to one another or at an angle with respect to one another. In a first position of the lever, the first arm of the lever is then preferably in a lowered position and the second arm is in a raised position. Due to the interaction and the geometric arrangement and/or formation of the lever and the webs, in particular the first web is then in the lowered position and the second web is in a raised position. In a second position of the lever, in which the first arm is in a raised position and the second arm is in a lowered position, it is preferably the other way around. A spring force is preferably applied to the webs by spring elements in this case, so that the web, the arm of which is in a lowered position, is pressed downward. Accordingly, the web, the rocker arm of which is in a lowered position, is preferably also in a lowered position, wherein the other web is pressed upward against the spring force by the force exerted by the raised rocker arm. In order to bring one of the two coupled webs into an upper position or an upward movement, the force exerted by the respective arm of the rocker therefore has to be greater than the spring force which is exerted on this web. The other web is pressed down by the spring force above all. The force exerted to lift one of the two webs is preferably generated by a motor, preferably electrically, but also pneumatically, by motor, and/or hydraulically. In particular, an electric linear motor used and/or linear actuator can also be comprised. However, it can also be preferred that a tilting movement can be triggered on the pivot bearing of the rocker by connecting a rotational axis of the rocker to a rotating shaft of an electric motor, in that the motor executes a partial rotation in one direction or the other.

It can also be preferred that a spring force is only applied to one web, so that preferably only this has to be actively lifted by a drive, while the other can be lifted by the spring force of this web via the coupling, for example if the drive of the web to which spring force is applied does not take place.

For the purposes of the invention, it is preferred that the discharge chute comprises sensors which are designed to monitor the movement of the webs of the sorting devices with regard to reaching their end positions. These sensors are preferably attached in the region of the linear drives. The linear drives are therefore preferably equipped with end position monitoring.

In a further aspect, the invention relates to a method for sorting pellets after they are produced in a tablet machine, wherein the pellets are guided into different channels of a discharge chute by one or more sorting devices in the discharge chute of the tablet machine, wherein the sorting devices each comprise a first web and a second web which are connected to one another via a linear drive in such a way that an upward movement of the first web causes a downward movement of the second web and vice versa. The definitions, technical effects, and advantages explained with regard to the discharge chute apply similarly to the method.

For the purposes of the invention, it is preferred that the discharge chute comprises a first, upper and a second, lower level, wherein the pellets pass into the discharge chute at the height of the first level and are guided by the one or more sorting devices to outlets of the discharge chute, wherein at least one outlet is part of the first level and at least one further outlet is part of the second level. The first level can, for example, comprise two outlets, wherein a right outlet represents the outlet of the good channel or first channel, while a further left outlet of the upper level represents the outlet of the sample or fourth channel. The outlet of the lower level of the discharge chute can for example be the outlet of the collecting or fifth channel, wherein the tablets from the second and third channels are collected in the collecting channel, i.e. the tablets from the bad channel and the reject channel.

In a further aspect, the invention relates to a method for sorting pellets after they are produced in a tablet machine, wherein the pellets are preferably guided by one or more sorting devices in a discharge chute of the tablet machine into different channels of the discharge chute, wherein the discharge chute comprises a first level and a second level, which are arranged one above the other, wherein the pellets pass into the discharge chute at the height of the first level and are guided by one or more sorting devices to outlets of the discharge chute, wherein at least one outlet is part of the first level and at least one further outlet is part of the second level.

The definitions, technical effects, and advantages explained with regard to the discharge chute apply similarly to the method.

In a preferred embodiment of the invention, the pellets are preferably guided by the one or more sorting devices in a discharge chute of the tablet machine into different channels of the discharge chute, wherein the sorting devices each comprise a first web and a second web, which are connected to one another via a linear drive in such a way that an upward movement of the first web causes a downward movement of the second web and vice versa.

For the purposes of the invention, it is preferred that the discharge chute comprises two sorting devices and five channels, wherein the pellets are guided using the first sorting device from a first channel into a third channel and the pellets are guided using the second sorting device from a first channel into a fourth channel. The pellets, which are rejected by means of compressed air at the scraper on the die plate of the tablet machine, are preferably guided into the second channel. It is further preferred that the pellets which are guided into the second or third channel are collected in a fifth channel, the collecting channel, wherein the fifth channel is part of the second level of the discharge chute.

### Exemplary Embodiment

An exemplary embodiment of the invention is described below, wherein the terms “right” and “left” are used as they result in a plan view of the discharge chute from the direction of the tablet machine. The so-called good channel is located on the right side in the first level of the discharge chute. From this channel there is a first branch to the left side of the chute for all rejected tablets that have exceeded or fallen below a mean value, whereby the tablets concerned are regarded as rejects. The mean value preferably relates to the measured pressing force signals, wherein the mean value is advantageously able to be calculated in a “sliding” manner. This reject channel ends at the left chute wall, but has an opening in the bottom as a passage into the lower second level. The second branch on the left side of the tablet discharge chute follows the first branch and is intended for the removal of sample tablets from the good production. The sample tablets leave the chute at essentially the same height as the good tablets in the first level. In the inlet region of the chute on the left side there is another channel, which is intended for the faulty individual tablets rejected using compressed air at the tablet scraper. This short channel is referred to as a bad channel and is delimited to the rear by an inclined connecting wall between the center wall and outer wall of the discharge chute, so that the tablets that are individually rejected at the scraper cannot reach the end of the chute. Since the bottom is also absent in the bad channel, the rejected tablets fall into the reject channel below, which forms the left side of the lower level.

In addition, according to the exemplary embodiment described here, the discharge chute comprises two sorting devices, which differ fundamentally from the conventional gates and sorting devices. The first sorting device can preferably also be referred to as a mean value gate. It has the task of reliably separating and rejecting the tablets that are outside a weight tolerance from the “good” tablets. This situation often occurs when the rotary press is started and when the machine is stopped. However, the pressing force mean value can also deviate considerably from the target value during production, which means that these tablets have to be rejected.

If the tablet machine is not equipped with tablet single sorting, this mean value gate is activated if the individual values are exceeded. The first sorting device is preferably able to remove flawed tablets from the tablet stream, and to reject approximately 2-3 tablets before and approximately 2-3 tablets after the flawed tablet, preferably with the bad tablet, whereby the risk of a flawed tablet reaching the good channel is minimized particularly reliably.

The sorting devices differ fundamentally from conventionally known sorting devices. The tabs or cages rotating around an axis are no longer used, but solid webs that move up and down essentially vertically through slots in the bottom of the discharge chute. The sorting devices each include two webs that move up and down reciprocally like a tandem or a rocker. In a center wall of the tablet discharge chute there are two openings that serve as entrances for the third and fourth channel. The first opening allows the rejected or mean value tablets to pass, the second opening the sample tablets. If these two openings were not closed during normal tablet production, then during production and when the sorting webs are actuated in the good channel, good tablets could possibly pass into the bad channel and bad tablets could pass into the sample channel. In order to avoid this, the sorting devices include, in addition to the sorting webs, so-called separating webs, which are designed to close the first and second opening in the center wall of the discharge chute. In other words: the two openings in the center wall of the chute can each be closed by a movable separating web.

If the first sorting device is activated when the rotary press is started, the sorting web of the first sorting device is raised by the linear drive in order to guide the tablets into the reject channel. At the same time, the corresponding separating web is pulled downwards due to a mechanical coupling with the sorting web, whereby the opening for the tablets to be rejected is exposed. The discharged tablets then fall down through the bottom opening into the collecting channel, which is located in the second level below the left chute side. The sorting device for the sample tablets, i.e. the second sorting device, is preferably essentially identical in construction to the first sorting device. The linear drives of the sorting devices are fastened on the bottom of the second level of the tablet chute. They preferably act on carrier plates of the sorting webs. The linear drives preferably act actively in both directions and they are preferably equipped with end position sensors so that reaching the two end positions of the sorting web and, indirectly, the separating web can be reliably monitored. Raising and lowering the webs is a very rapid process, so that an optimal sorting result can be achieved.

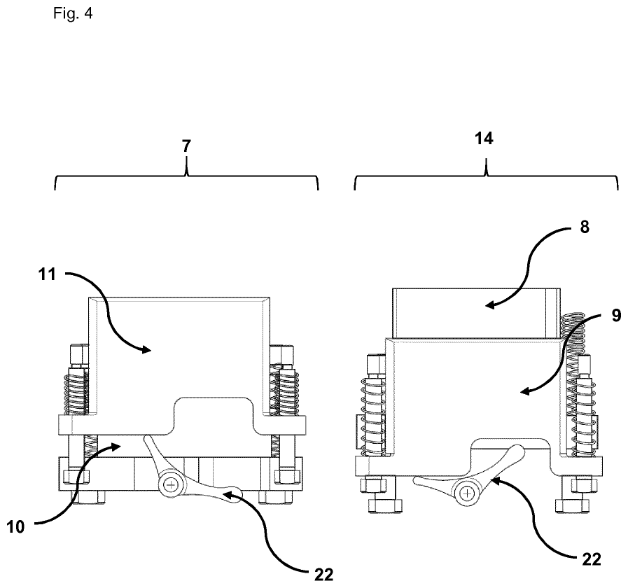

For the purposes of the invention, it is preferred that the gates or the sorting devices in the separating wall are raised by a rocker when the corresponding sorting gate is at the bottom, preferably in level 2, in the idle position. If, for example, the sorting gate in the good channel is raised by the lifting drive, the respective other gates are pressed down by springs because the rocker releases the gate. The springs are shown in FIG. 4, for example. For the purposes of the invention, it is preferred to also designate the lifting drive as a linear drive or as a drive for the sorting webs.

For the purposes of the invention, it is preferred that the proposed discharge chute can also be used in conjunction with those tablet machines which have pneumatic individual sorting of bad tablets. Tablets recognized as “bad” are usually rejected using compressed air. The corresponding sorting nozzle is preferably located in a tip of the tablet scraper, since this is in particular where the tablets are located individually on the die plate. If a tablet is recognized to be flawed during the pressing process, a blast of compressed air is triggered when the tablet reaches the sorting nozzle in the tablet scraper, which moves the tablet radially outward so that it lands in the opening of the bad channel of the tablet discharge chute. Since this channel segment preferably has no bottom or an opening in the bottom, the rejected tablet falls down into the second level in the collecting channel.

The invention will be described in greater detail in reference to the following figures, in the figures:

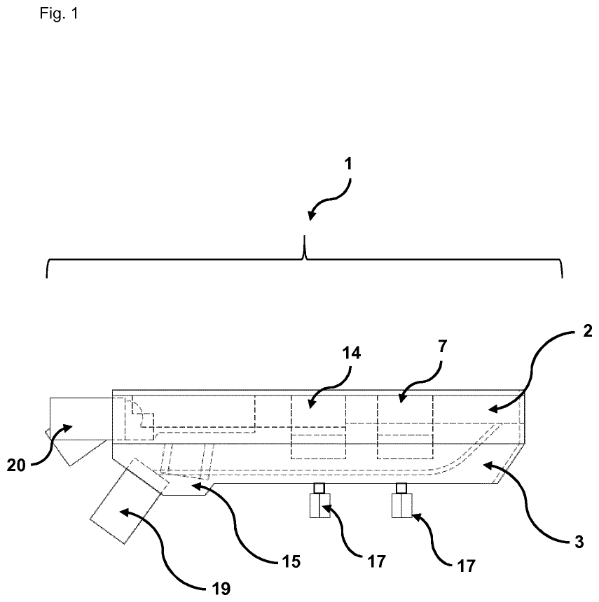

FIG. 1 shows a side view of a preferred embodiment of the tablet discharge chute

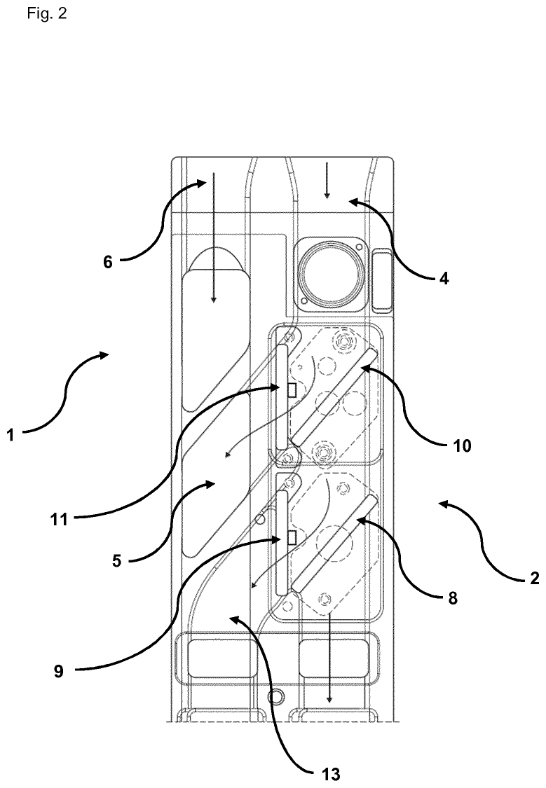

FIG. 2 shows a detailed view of a preferred embodiment of the tablet discharge chute

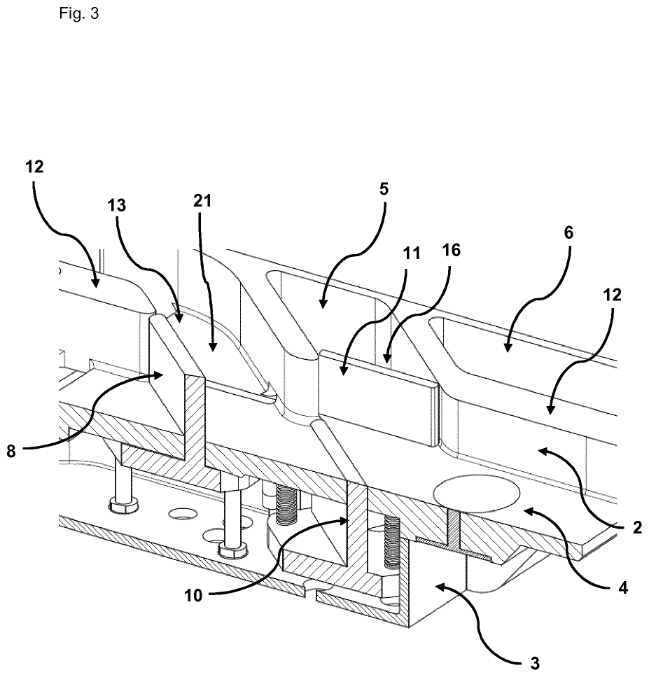

FIG. 3 shows a section through a preferred embodiment of the tablet discharge chute

FIG. 4 shows an illustration of the coupled adjustment of two webs of a sorting device

FIG. 1 shows a side view of a preferred embodiment of the tablet discharge chute (1). In particular, FIG. 1 shows a section through the proposed discharge chute (1). The linear drives (17) for the sorting devices (7, 14), which can preferably also be referred to as gates, are fastened on the bottom of the lower level (3) of the discharge chute (1). Furthermore, the outlet (19) for the collecting channel (15) is shown, in which the tablets from the bad channel (6) and the reject channel (5) collect after they have fallen through openings in the bottom of the first level (2) and thus have passed into the collecting channel (15) of the second level (3). The outlet (18) for the sample tablets is concealed in FIG. 1 by the outlet (20) for the good tablets, but is arranged behind it.

FIG. 2 shows a detailed view of a preferred embodiment of the tablet discharge chute (1). In particular, FIG. 2 shows a plan view of the upper level (2) of the proposed tablet discharge chute (1). In the proposed discharge chute (1), a maximum of two channels (4, 5, 6, 13) are arranged next to one another, although the discharge chute (1) preferably comprises a total of four channels (4, 5, 6, 13) for sorting pellets. This advantageous arrangement of the channels (4, 5, 6, 13) is preferably enabled by the fact that the discharge chute (1) comprises two levels (2, 3) which are arranged one above the other. This advantageously makes it possible for the discharge chute (1) to function as a 4-lane chute which is usually twice as wide. In addition, the discharge chute (1), which is placed on two levels (2, 3), enables a completely different division of the individual channels (4, 5, 6, 13) than is known from conventional discharge chutes from the prior art. The plan view also shows the outlet (20) for the good tablets, which is part of the upper level (2) of the discharge chute (1).

FIG. 2 also shows the following details of the invention: The “good” tablets are guided by the tablet scraper on the die plate into the right good channel (4) of the tablet discharge chute (1). The good channel (4) is located in the upper level (2) of the proposed discharge chute (1). When the tablet machine is started and stopped or in the event of material feed problems, the tablets are automatically rejected by the sorting web (10) of the first sorting device (7) and guided into the collecting channel (15), which is located in the lower second level (3) of the discharge chute (1). If sample tablets are required from the production of goods, they are guided into the sample channel (13) using the sorting web (8) of the second sorting device (14). Flawed individual tablets are guided via the pneumatic individual sorting into the left inlet of the tablet discharge chute in the upper level (2) of the discharge chute (1), to which the bad channel (6) connects. The flawed tablets fall down through the bottom opening into the second level (3) of the discharge chute (1) and land in the collecting channel (15).

The discharge chute (1) comprises a center wall (12) which divides the discharge chute (1) into two substantially similarly sized side halves. The center wall (12) comprises openings (16, 21) through which the tablets can pass from the good channel (4) into the reject channel (5) or into the sample channel (13). The first opening (16) in the center wall (12) represents the entrance (16) for the reject channel (5). This entrance (16) can be blocked or closed using the separating web (11) of the first sorting device (7) so that no tablets can pass into the reject channel (5). The second opening (21) in the center wall (12) represents the entrance (21) for the sample channel (13). This entrance (21) can be blocked or closed using the separating web (9) of the second sorting device (14) so that no tablets can pass into the sample channel (13). According to the invention, it is preferred that the sorting web (10) and the separating web (11) form the first sorting device (7) and that the sorting web (8) and the separating web (9) form the second sorting device (14). For the purposes of the invention, it is preferred that the sections of the first channel (4) and of the fourth channel (13) comprise openings for dust extraction devices.

FIG. 3 shows a section through a preferred embodiment of the tablet discharge chute (1). In particular, FIG. 3 shows further details and the function of the sorting devices (7, 14). On the right side of FIG. 3, the sorting web (8) of the second sorting device (14) is in the working position, which is also referred to as the extended position of the sorting web (8). The separating web (9) of the second sorting device (14) is in the lower position, which is preferably also referred to as the idle or bottom position. When the separating web (9) of the second sorting device (14) is in the idle position, the sample tablets, which preferably come from the good channel (4) or from the first subset of pellets, can pass into the sample channel (13). The two webs (8, 9) of the second sorting device (14) are preferably coupled by a rocker (22). This rocker (22) is rotatably connected to the sorting web (8) on the right side and is fixedly mounted in the middle.

On the left side, the return springs of the separating web (9) of the second sorting device (14) are applied to the lever (22). When the sorting web (8) is moved upwards by the linear drive (17), the rocker (22) is also pivoted and thereby allows the separating web (9) to move downwards due to the spring force.

If the sorting web (8) is pulled down, the separating web (9) is automatically raised by means of the rocker (22). The underlying mechanism for the sorting devices (7, 14), which enables the webs (8, 9 and 10, 11) to be coupled, is preferably located in the lower, second level (3) of the proposed tablet discharge chute (1), namely in the example of the invention shown in FIG. 3 on the right side of the collecting channel (15). The linear drives (17) are located in the center under the carrier plates of the sorting webs (8, 10) and are each detachably fastened to the bottom plate of the lower level (3) using a quick-release fastener. For the purposes of the invention, it is preferred that the sorting webs (8, 10) are preferably also referred to as first webs, while the separating webs (9, 11) are preferably also referred to as second webs.

FIG. 3 shows a center wall (12), which has two openings (16, 21), in the center of the discharge chute (1). The first opening represents the entrance (16) of the reject channel (5), while the second opening represents the entrance (21) of the sample channel (13). In the front right region of the upper level (2) of the discharge chute (1), the bad channel (6) is located, which picks up tablets found to be flawed directly from the die plate of the tablet machine, which were separated from the “good” tablets using a blast of compressed air at the tablet scraper, wherein the “good” tablets form the first subset of pellets that pass into the good channel (4). The first level (2) of the discharge chute (1) is preferably at the same height as a horizontal plane of the die plate, which corresponds to the surface of the die plate.

FIG. 4 shows an illustration of the coupled adjustment of two webs (8 and 9 or 10 and 11) of a sorting device (7 or 14) of the proposed discharge chute (1). The two separating webs (9, 10) of the first and second sorting devices (7, 14) can be seen in the foreground. The dividers (9, 10) have a recess on their underside, the edge of which interacts in each case with a rocker (22). The interaction of the rocker (22) and the linear drives (17) ensures that an upward movement of a sorting web (8, 11) results in an upward movement of the corresponding separating web (9, 10) and vice versa. The coupling mechanisms that enable the coupled movement of the webs (8 and 9 or 10 and 11) of the sorting devices (7, 14) are preferably housed in the region of the lower level (3) of the discharge chute (1), preferably below the good channel (4), which is part of the first level (2) of the discharge chute (1).

### LIST OF REFERENCE NUMERALS

1 tablet discharge chute
2 first, upper level of the discharge chute
3 second, lower level of the discharge chute
4 good channel or first channel
reject channel or third channel
6 bad channel or second channel
7 first sorting device
8 sorting web for sample tablets or sorting web of the second sorting device
9 separating web for sample tablets or separating web of the second sorting device
10 sorting web for reject tablets or sorting web of the first sorting device
11 separating web for reject tablets or separating web of the first sorting device
12 center wall
13 sample channel or fourth channel
14 second sorting device
15 fifth channel or collecting channel
16 entrance for the reject channel
17 drive for the sorting webs, linear drive
18 outlet for sample tablets
19 outlet of collecting channel
20 outlet of good channel
21 entrance for the sample channel
22 rocker

1. A discharge chute (1) for a tablet machine comprising a first channel (4) and one or more further channels (5, 6, 13) for receiving pellets,
characterized in that
the discharge chute (1) comprises a first upper level (2) and a second lower level (3), wherein the two levels (2, 3) are provided arranged one above the other and the first upper level (2) comprises the first channel (4), as well as entrances for the further channels (5, 6, 13), wherein the discharge chute (1) comprises one or more sorting devices (7, 14) which are designed to release or block at least some of these entrances, whereby the pellets are divided into subsets of pellets.

2. The discharge chute (1) according to claim 1,
characterized in that
at least one of the subsets of pellets passes into the second level (3) via at least one of the further channels (5, 6, 13).

3. The discharge chute (1) according to claim 1 or 2,
characterized in that
the sorting devices (7, 14) each comprise a first web (8, 10) and a second web (9, 11), wherein the webs (8-11) are connected to one another via a linear drive (17) in such a way that an upward movement of the first web (8, 10) causes a downward movement of the second web (9, 11) and vice versa.

4. The discharge chute (1) according to claim 3
characterized in that
the webs (8-11) of the sorting devices (7, 14) extend obliquely and/or essentially in parallel to a movement of a pellet flow in the first channel (4) in the first upper level (2) of the discharge chute (1).

5. The discharge chute (1) according to claim 3 or 4,
characterized in that
the linear drives (17) are provided fastened to a bottom of the second lower level (3) of the discharge chute (1).

6. The discharge chute (1) according to one or more of claims 3 to 5
characterized in that
the discharge chute (1) comprises sensors, which are designed to monitor the movement of the webs (8-11) of the sorting devices (7, 14) with respect to reaching their end positions.

7. The discharge chute (1) according to one or more of the preceding claims, characterized in that
the first channel (4) is designed as a continuous channel at the end of which there is an outlet (20) for a first subset of pellets.

8. The discharge chute (1) according to one or more of the preceding claims, characterized in that
the first upper level (2) comprises entrances for a second channel (6), third channel (5), and fourth channel (13), which are designed to receive a second, third, and fourth subset of pellets, wherein sections of the corresponding channels (5, 6, 13) comprise openings in a bottom of the first upper level (2).

9. The discharge chute (1) according to one or more of the preceding claims, characterized in that
the second and third subset of pellets pass through the openings in the bottom of the first upper level (2) into the second lower level (3).

10. The discharge chute (1) according to one or more of the preceding claims, characterized in that
the fourth subset of pellets passes into an outlet (18) for the fourth subset of pellets, wherein this outlet (18) is part of the first upper level (2).

11. The discharge chute (1) according to one or more of the preceding claims, characterized in that
the second lower level (3) comprises an outlet (19) for the second and third subset of pellets.

12. A method for sorting pellets after they are produced in a tablet machine, wherein the pellets are guided by one or more sorting devices (7, 14) in a discharge chute (1) of the tablet machine into different channels (4, 5, 6, 13) of the discharge chute (1), wherein the sorting devices (7, 14) each comprise a first web (8, 10) and a second web (9, 11) which are connected to one another via a linear drive (17) in such a way that an upward movement of the first web (8, 10) causes a downward movement of the second web (9, 11) and vice versa.

13. The method according to claim 12, characterized in that
the discharge chute (1) comprises a first upper level (2) and a second lower level (3), wherein the pellets pass into the discharge chute (1) at the height of the first upper level (2) and are guided by one or more sorting devices (7, 14) to outlets (18-20) of the discharge chute (1), wherein at least one outlet (18 or 20) is part of the first upper level (2) and at least one further outlet (19) is part of the second lower level (3).

14. The method according to claim 12 or 13, characterized in that
the discharge chute (1) comprises two sorting devices (7, 14), wherein the pellets are guided using the first sorting device (7) from a first channel (4) into a third channel (5) and the pellets are guided using the second sorting device (14) from a first channel (4) into a fourth channel (13).

15. The method according to one or more of claims 11 to 14,
characterized in that
the pellets, which are rejected by means of compressed air at a scraper on a die plate of the tablet machine, are guided into the second channel (6).

16. The method according to one or more of claims 11 to 15,
characterized in that
the pellets which are guided into the second channel (6) or third channel (5) are collected in a fifth channel (15), wherein the fifth channel (15) is part of the second lower level (3) of the discharge chute (1).
